(19) United States
(12) Patent Application Publication
(10) Pub. No.: US 2005/0044724 A1
(43) Pub. Date: Mar. 3, 2005

(54) Structure of hair scissors

(75) Inventor: Da-Yung Lin, Yung-Ho City (TW)

Correspondence Address: TROXELL LAW OFFICE PLLC, SUITE 1404, 5205 LEESBURG PIKE, FALLS CHURCH, VA, 22041, US

(73) Assignee: Ming Chia Company Limited

(21) Appl. No.: 10/766,815

(22) Filed: Jan. 30, 2004

(30) Foreign Application Priority Data
Aug. 28, 2003 (TW) 92215586

(51) Int. Cl. B26B 13/28

(52) U.S. Cl. 30/266; 30/226

(57) ABSTRACT

An improved structure of hair scissors, in particular containing a set of especially designed of bolt and nut assembly mounted on the blade instead of the pivot screw. The bolt and nut assembly comprises at least a bolt, a plastic washer, a metal washer, a circlet and a lock nut. Especially the bolt has a threaded square shank on which the plastic washer, two blades, the metal washer, and the circlet are mounted in order and finally locked by the lock nut. The bolt head has an oval hole to receive the turning-in of the bolt thread shank. The bolt and the nut are easily assembled to form a hair scissors to gain diversity in hair cutting.

### BACKGROUND OF THE INVENTION

1. Field of the Invention

This Invention relates to a new structure of hair scissors, particularly it is easy to combine multiple scissors into a single hair scissors for convenient in hair cutting and diverse in hair styling.

2. Description of the Related Art

In general in the process of hair cutting or hair dressing, the barber or the hair stylist has to change more than frequently from the shears, scissors, clippers and thinners to achieve the hair style the customer wants. The change of hair-cutting tool is time consuming. The barber or the hair stylist has to hold two pairs of scissor or shears for convenience, but the hair cutting tools the barber or the hair stylist holds are not yet combined into one tool, sometime they may render finger snapping or injury. In other word, it will take long time for the barber or the hair stylist becoming skilled in operating two tools in one time. Now a new scissors is available as shown in FIG. 1, in which a long bolt is employed to unite two pair of scissors together. This design achieves the convenience, but it is hard to replace when one scissors is damaged or out of work.

The conventional combination designs of hair scissor is single an addition of process but costing more to the barber or hair stylist to buy and the customer to share, definitely it is not economical.

Viewing the weaknesses stated above, the inventor has dedicated his rich professional experience and knowledge for year to improving the combination design and finally come up this “structure of hair scissors” in hopes to provide the barbers and the hair stylists more convenient and smoother operation.

### SUMMARY OF THE INVENTION

The main object of this invention is to provide an improved structure of hair scissors in which two blades are overlapped connected by a bolt and nut assembly for easily and fast connecting a plurality of scissors into an integral form to gain convenience in hair cutting or hairdressing and diverse styles.

To achieve the above mentioned object as well as the efficiency, the technology this invention has applied is the bolt and nut assembly which consists of a bolt, a plastic washer, a metal washer, a circlet and a lock nut. In particular the bolt is made of a threaded square shank to link the plastic washer, two blades, metal washer, and circlet and finally locked with the lock nut. The other end of the bolt is the head with an oval hole on its bottom to receive the threaded square shank which is therefore screwed in the hole and locked therein. The linkage composed of the bolt head and the lock are capable of combine several hairs scissor integrally.

This invention is explained in great detail with the aid of embodiments as illustrated in the drawing attached.

### BRIEF DESCRIPTION OF THE DRAWINGS

FIG. 1 shows the appearance of the prior art of hair scissor.

FIG. 2 shows the schematic diagram of detail disassembly of the hair scissor of this invention.

FIG. 3 shows appearance of the hair scissors of this invention.

FIG. 4 shows the disassembly of the hair scissors of this invention.

FIG. 5 shows the assembly of the hair scissors of this invention.

FIG. 6 shows the partial disassembly of the hair scissors of this invention.

FIG. 7 shows the cross section of the hair scissors of this invention.

FIG. 8 shows another embodiment of the hair scissors of this invention.

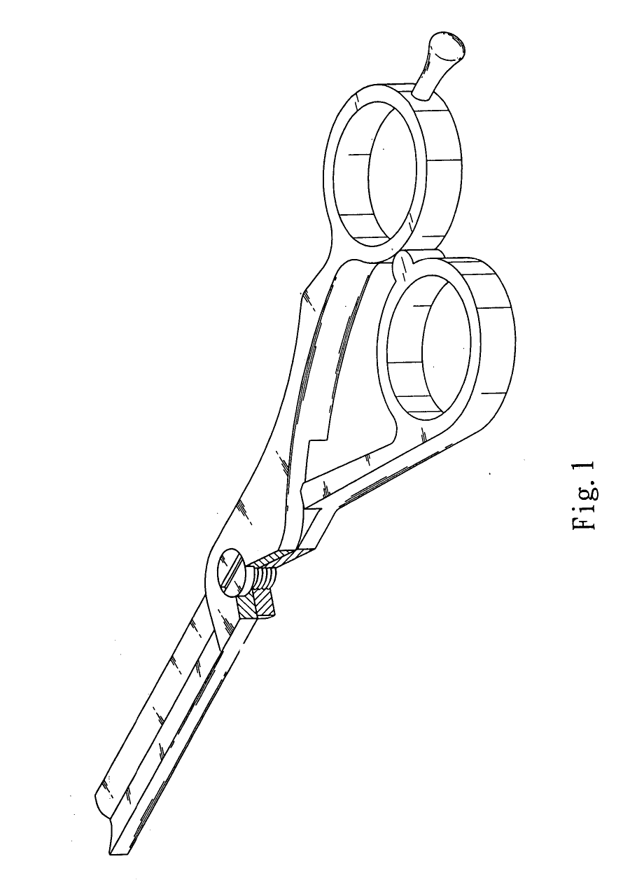

### DETAILED DESCRIPTION OF THE PREFERRED EMBODIMENT

Referring to Figs. from 2 through 8, the structure of hair scissor provided in this invention to replace the pivot screw 30 which holds two blades 10 and the handles 20 together in the hair scissors 1 with a especially designed bolt and nut assembly 40. The bolt and nut assembly 40 is extendable to hold several hair scissors together for diverse operation in hair cutting and hairdressing.

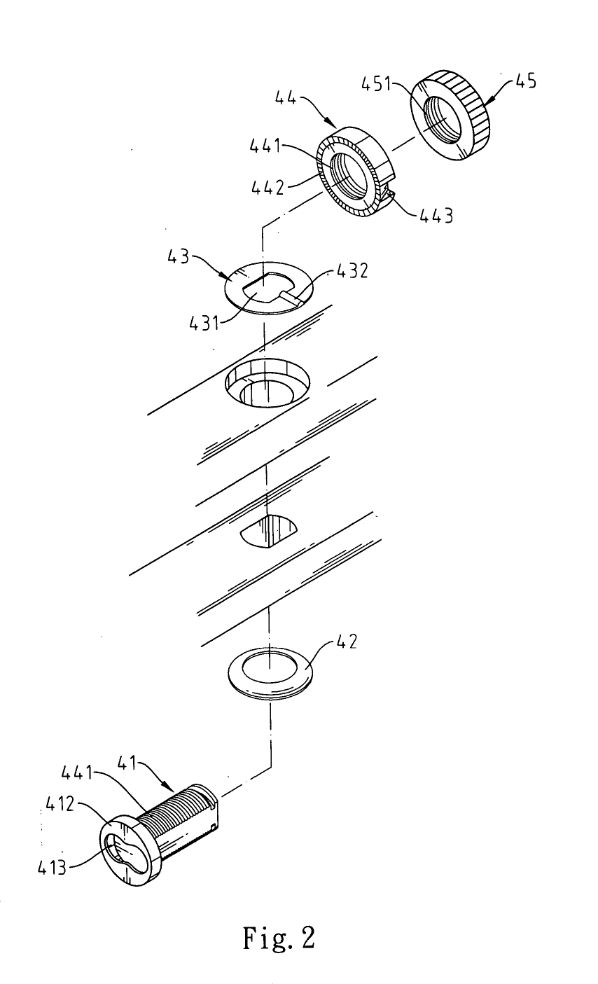

As shown in FIG. 2, the bolt and nut assembly 40 contains the bolt 41, the plastic washer 42, and the metal washer 43, the circlet 44 and the lock nut 45. In which the bolt 41 has a treaded square shank 411 and a bolt head 412 with an oval hole 413 to lock therein the threaded square shank 411.

The plastic washer 42 is in the form of central hollow cone, sleeved on the thread shank 411 of the bolt 41 for purpose of adjusting the tightness of the bolt and nut assembly 40.

The metal washer 43 has a square hole 431 in the center to align with the square shank 411 of the bolt 41. The metal washer 43 has a projected rib 432 along the rim of the metal washer 43.

The circlet 44 has a link hole 441 to receive the square shank 411 with the corrugated surface 442 at one end. When the circlet 44 overlaps on the metal washer 43, the corrugated surface 442 will catch the projected rib 432 of the metal washer to produce a strong restraint on the bolt rotation. The circlet 44 has a flute 443 on the other end.

The lock nut 45 will receive the bolt 41 with inner threaded hole 451 to lock up the square shank 411.

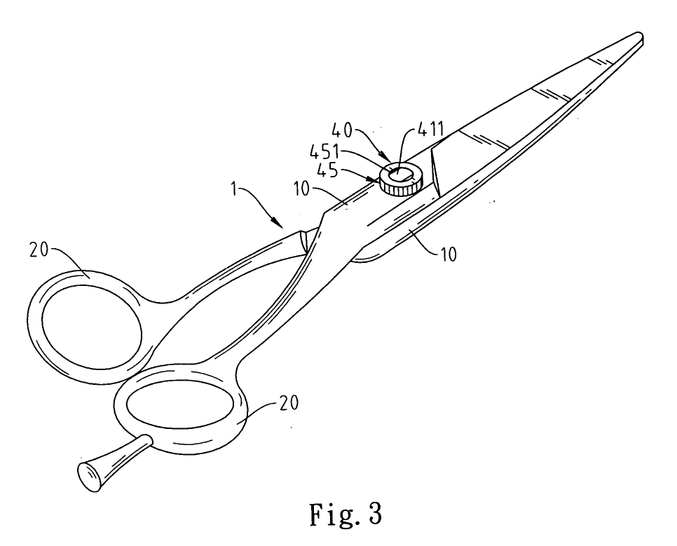

In assembling, the plastic washer 42, the metal washer 43, the circlet 44 are overlapped on the square shank 411 and locked by the lock nut 45 to form an integral structure of the hair scissors 1 as shown in FIG. 3.

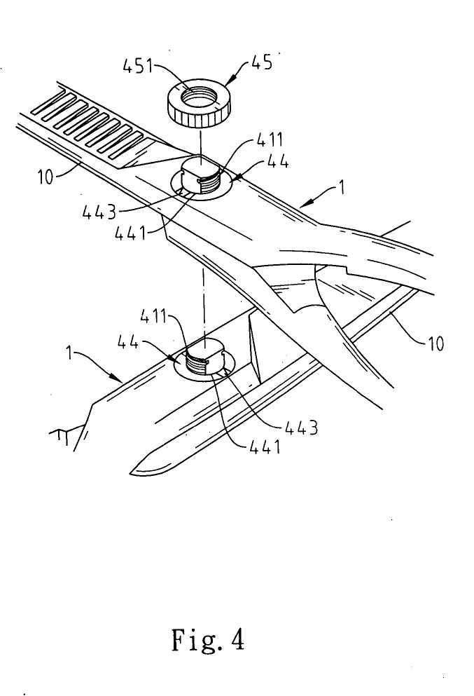

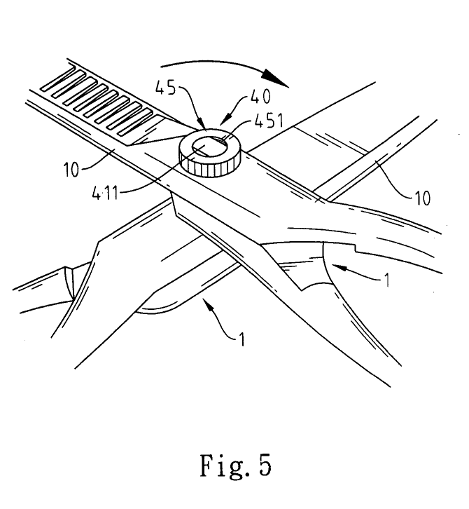

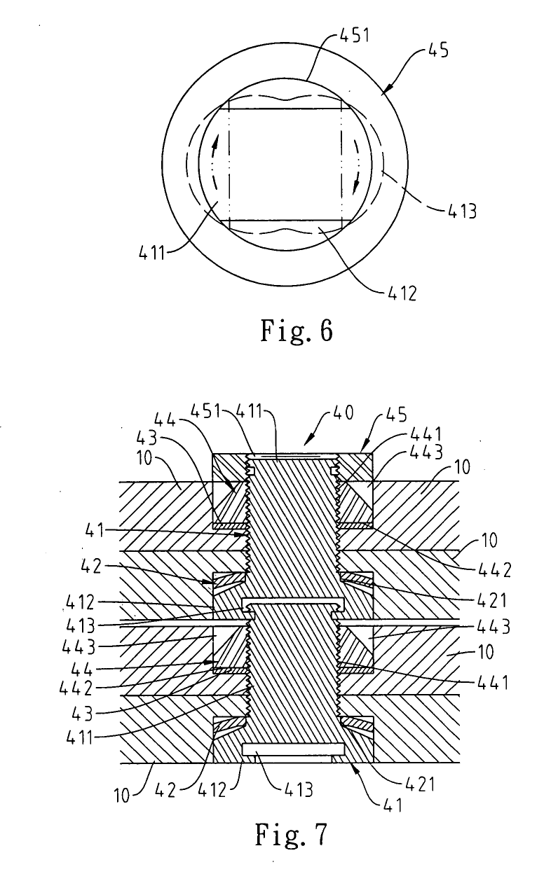

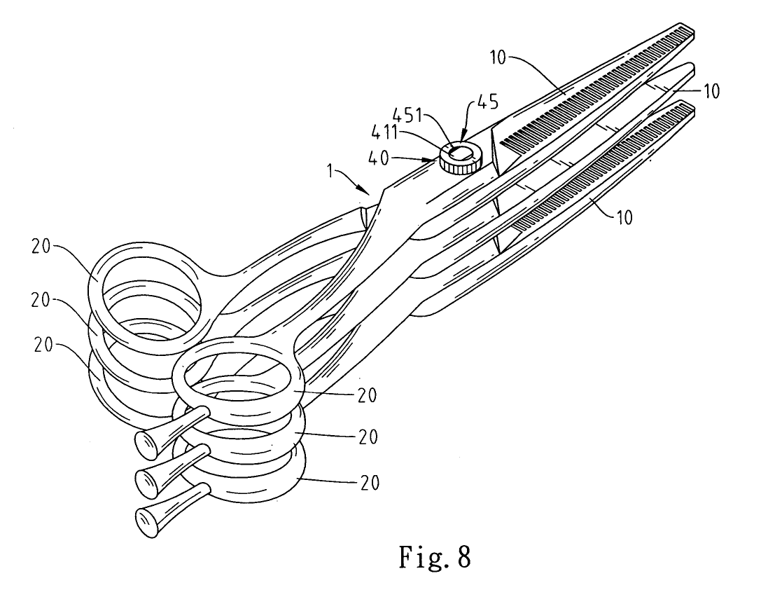

If two sets of hair scissors 1 are connected together as shown in FIG. 4, take off the lock nut 45 of the bolt and nut assembly 40 and insert the square shank 411 of the blade 10 into the oval hole 413 of the bolt head 412, then turn in and lock the square shank 411 therein. As shown in Figs. from 5 through 7, the circlet 45 will link two overlapped scissors 1. The extended connection of the bolt and nut assembly 40 will combine several sets of hair scissors together as shown in FIG. 8.

The hair scissors provided in this invention eliminates much trouble for the barbers and hair stylists in changing the scissors, shears and thinners. The users have the option to make any combination as they want without changing the appearance, structure with high interchangeability and practice.

The improved structure of hair scissors has benefited the practicable effectiveness, justified for a grant of new patent.

1. A structure of the hair scissors employs a bolt and nuts assembly to connect the blades and the handles together, which can be extended to connect several hair scissors in combination to achieve diverse operation; the main characteristic is: the bolt and nut assembly comprises a bolt, a plastic washer, a metal washer, a circlet, and a lock nut; in which
the bolt has a threaded square shank and the bolt head has an oval hole to receive and hold the square shank of the bolt;
the plastic washer is in the form of center hollow cone, sitting on the square shank for proper adjustment of tightness of the bolt and nut assembly;
the metal washer has a square hole to be sleeved in the square shank. The metal washer has projected rib formed on its rim;
the circlet permits the insertion of the square shank with corrugated surface to catch the projected rib on the metal washer so as to restrain the rotation. There is flute on the other end of the circlet;
the lock nut provides the inner thread to lock up the thread on the square shank. It also serves as a protective measure to prevent the square shank extended outward;
this bolt and nut assembly is capable of combine several scissors into an integral form to gain the diverse operations in hair cutting and hairdressing.
